(19) United States
(12) Patent Application Publication
(10) Pub. No.: US 2016/0052578 A1
(43) Pub. Date: Feb. 25, 2016

(54) SEAT TUBE WITH A CONTINUOUS CURVE CONFIGURATION FOR A BICYCLE

(71) Applicant: VROOMEN-WHITE-DESIGN INC., Toronto (CA)

(72) Inventor: MARK REMENNIK, Toronto (CA)

(21) Appl. No.: 14/784,298

(22) PCT Filed: Apr. 15, 2014
(86) PCT No.: PCT/CA2014/000349

§ 371 Date: Oct. 14, 2015

Related U.S. Application Data
(60) Provisional application No. 61/811,928, filed on Apr. 15, 2013.

(51) Int. Cl. B62J 1/08

(52) U.S. Cl. CPC B62J 1/08

(57) ABSTRACT

A bicycle frame. The frame comprising a bottom bracket; a top tube, a head tube, a down tube and a seat tube, and first and second seat stays, and first and second chain stays. One end of the top tube and one end of the down tube is affixed to the head tube, and the other end of the top tube being affixed to one end of the seat tube. One end of each of the seat stays is affixed to the seat tube, and the other end of each of the seat stays is affixed to respective ends of the chain stays. The other end of the down tube and the other end of the seat tube and the other end of each of the chain stays form a juncture for connecting or affixing the bottom bracket. According to an embodiment, the seat tube comprises an upper section configured for attachment to the top tube in the bicycle frame; a lower section configured for attachment to the bottom bracket in the bicycle frame; and a curved section, the curved section spanning at least a portion between the upper section and the lower section.

### FIELD OF THE INVENTION

This invention relates to wheeled vehicles or cycles, and more particularly to a seat tube with a curve configuration for a bicycle.

### BACKGROUND OF THE INVENTION

Bicycle designers continue trying to reduce the aerodynamic drag of bicycles in order to increase riders speed and reduce rider fatigue. Bicycle designers continue also to try and reduce the weight of bicycle frames and components while maintaining strength and rigidity of the designs.

There remains a need for improvement in the art.

### BRIEF SUMMARY OF THE INVENTION

The present invention is directed to a bicycle frame assembly and/or a seat tube with a curved shape or configuration.

According to one embodiment, the present invention comprises a seat tube for use with a bicycle frame, the seat tube comprising: an upper section configured for attachment to a top tube in the bicycle frame; a lower section configured for attachment to a bottom bracket in the bicycle frame; and a curved section, the curved section spanning at least a portion between the upper section and the lower section.

According to another embodiment, the present invention comprises a cycle frame comprising: a bottom bracket; a top tube, a head tube, a down tube and a seat tube; one end of the top tube and one end of the down tube being affixed to the head tube, and another end of the top tube being affixed to one end of the seat tube; first and second seat stays, and first and second chain stays, and one end of each of the seat stays being affixed to the seat tube, and another end of each of the seat stays being affixed to respective ends of the chain stays; another end of the down tube and another end of the seat tube and another end of each of the chain stays forming a juncture for connecting or affixing the bottom bracket; the seat tube comprising, an upper section configured for attachment to the top tube in the bicycle frame; a lower section configured for attachment to the bottom bracket in the bicycle frame; and a curved section, the curved section spanning at least a portion between the upper section and the lower section.

Other aspects and features of the present invention will become apparent to those ordinarily skilled in the art upon review of the following exemplary embodiments of the invention in conjunction with the accompanying figures.

### BRIEF DESCRIPTION OF THE DRAWINGS

Reference will now be made to the accompanying drawings, which show by way of example, embodiments according to the present invention, and in which:

FIG. 1 shows a bicycle comprising a frame assembly with seat tube configuration according to an embodiment of the present invention;

FIG. 2 shows the frame assembly for the bicycle of FIG. 1 in isolation; and

FIG. 3 shows a portion of the seat tube assembly according to an embodiment of the present invention in closer detail.

Like reference numerals indicate like elements or components in the drawings.

### DETAILED DESCRIPTION OF THE EMBODIMENTS

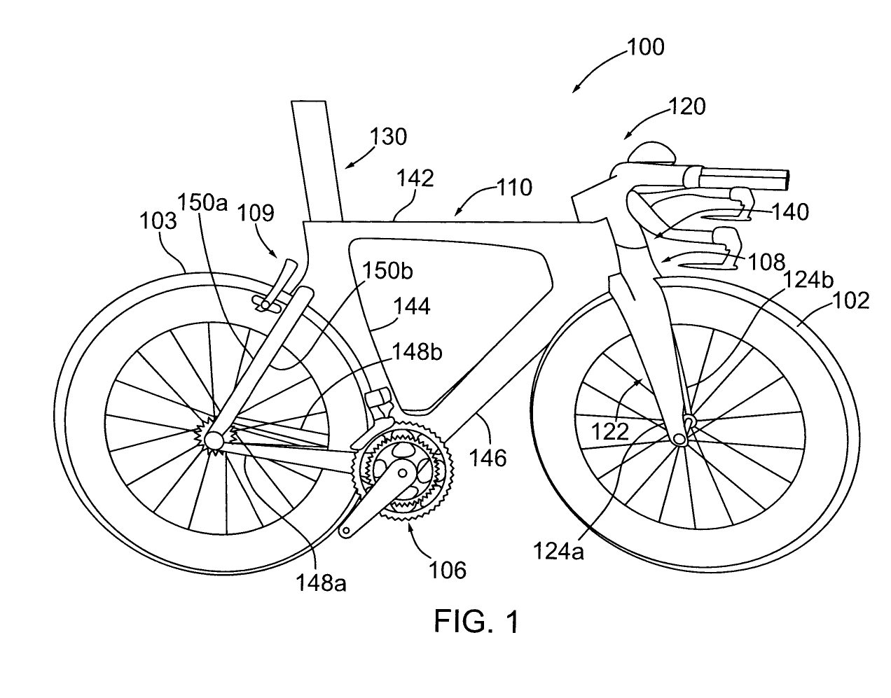

Reference is first made to FIG. 1, which shows a bicycle indicated generally by reference 100 and configured with a seat tube configuration according to an embodiment of the present invention. While embodiments according to the present invention are described in the context of a bicycle, it will be appreciated and understood that the invention may be suitable for other frame geometries or wheeled vehicle configurations.

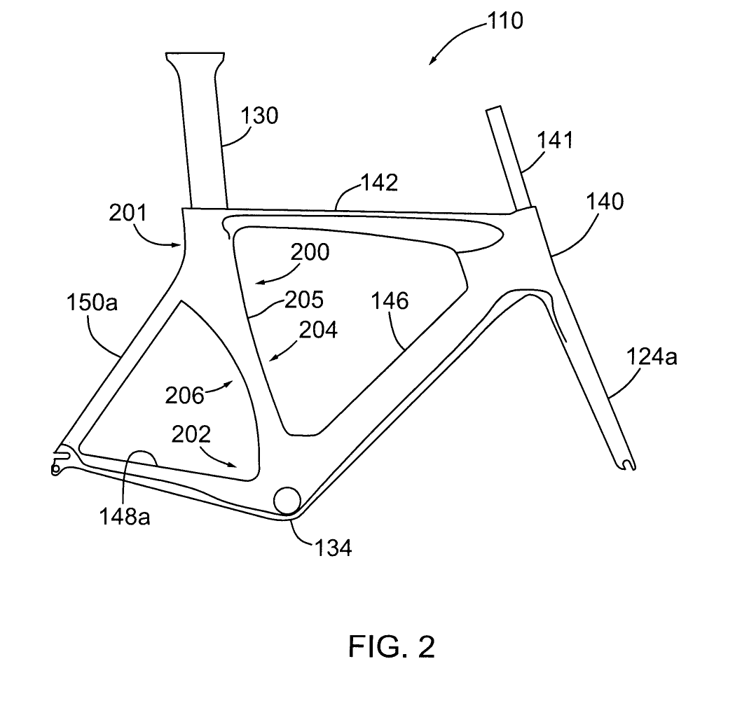

The bicycle 100 comprises a frame indicated generally by reference 110 and front and rear wheels indicated by references 102 and 103, respectfully. The frame 110 is assembled with, a peddle crank assembly 106, a front brake assembly 108 and a rear brake assembly 109, a handle bar and headstock indicated generally by reference 120, and a front fork assembly 122, in known manner. The front fork assembly 122 is coupled to the headstock 120 and comprises right 124a and left 124b forks, which are affixed to the front wheel 102. The frame 110 comprises, a seat post 130 (configured to receive a seat (not shown)), a bottom bracket 134, a head tube 140 (configured to receive a handle bar stem 141 as shown in FIG. 2), a top tube 142, a seat tube 144, a down tube 146, a pair of chain stays 148a, 148b and a pair of seat stays 150a, 150b, which are affixed at respective ends using known techniques, such as welding or detachable fasteners, adhesives and/or laminate layers (e.g. for composite frames), etc., to form the bicycle frame 110, as will be familiar to one skilled in the art. It will also be apparent to one skilled in the art that the frame 110 can comprise additional tubes or tube configurations, and the frame 110 depicted in FIG. 1 is merely illustrative of a typical bicycle frame having a seat tube in accordance with embodiments according to the present invention as described in more detail below.

The seat tube 144 comprises a curved configuration according to an embodiment of the invention as will now be described in more detail with reference to FIG. 2.

FIG. 2 shows the bicycle frame 110 and like elements/components are indicated by like reference numerals. The bicycle 110 includes a seat tube with a curve configuration according to an embodiment of the present invention. In FIG. 2, the seat tube is indicated generally by reference 200. As shown, the seat tube 200 comprises an upper or top section 201, a lower or bottom section 202, a mid or intermediate section 203, a front or leading surface or edge 204 and a rear or trailing surface or edge 206. The upper or top section 201 forms a junction with the top tube 142 and the seat stays 150a, 150b. The lower or bottom section 202 forms a junction or connection with the bottom bracket 134 and the chain stays 148a and 148b.

According to an embodiment, the front edge or surface 204 of the seat tube 200 comprises a continuous curve with a concave shape indicated by reference 205 from the bottom bracket 134 to the top tube 142. According to one aspect, the concave shape 205 of the seat tube 204 comprises a curve with a constant or continuous radius. According to another aspect, the concave shape 205 of the seat tube 204 comprises varying curved portions or sections, i.e. two or more radii. According to another embodiment, the top or upper section 201 and/or the bottom or lower section 202 comprise a tangential configuration in relation to the top tube 142 and/or the bottom bracket 134, respectively. According to another embodiment, the top section 201 of the seat tube 200 extends above the top tube 142, and may comprise a continuation of the concave shape of the continuous curve 205.

According to another aspect, and as shown in FIG. 2, the rear surface or trailing edge 206 of the seat tube 200 comprises a rear cutaway with a concave shape indicated generally by reference 207. The rear cutaway 207 extends substantially from the bottom or lower section 202 of the seat tube 200 (i.e. at the bottom bracket 134) to the seat stays 150a, 150b as shown in FIG. 2. The concave shape of the rear cutaway 207 substantially follows the radial shape of the rear wheel 103. According to another aspect, the concave shape of the rear cutaway 207 comprises a partial radial shape. According to another aspect, the concave shape of the rear cutaway 207 comprises more than one radial shape each with a different radius.

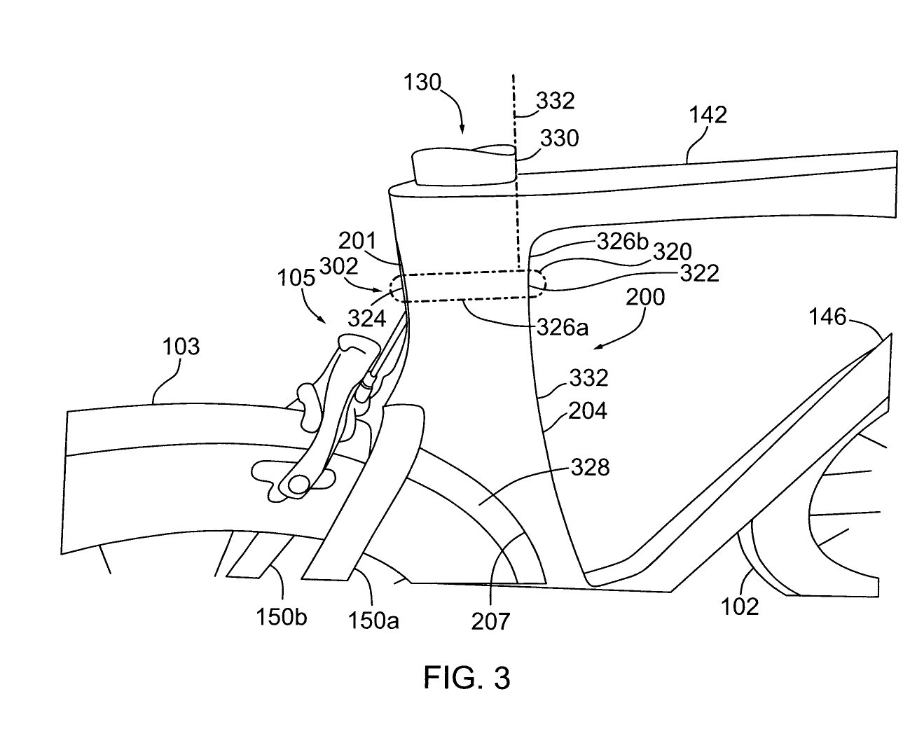

According to another embodiment, the top section 201 of the seat tube 200 comprises a concave rear edge or surface above the seat stays 150a, 150b, as shown in FIG. 3 and indicated generally by reference 302. The concave rear edge 302 is configured to allow various designs or configurations for the rear brakes 109 to be utilized and/or alignment of the rear brakes 109 to be maintained. According to another aspect, the concave rear edge 302 is configured to provide a smooth transition between the seat stays 150a, 150b and the top section 201 and the seat post 130. According to another embodiment, at the top section 201, the front edge or surface 204 of the seat tube 200 is parallel to a corresponding section 304 on the rear edge or surface of the seat tube 200 as shown in FIG. 3. This configuration of the respective front and rear edges can provide improved air flow characteristics, and/or an aesthetically pleasing appearance. According to another embodiment, the top section 201 comprises a shape or configuration for integrating (i.e. housing or partially housing) the rear brake assembly 109.

According to another embodiment, the seat tube 200 is configured with aerofoil cross-sectional shape as indicated generally by reference 320 in FIG. 3. According to embodiment, the aerofoil 320 comprises a leading edge 322 which is formed with an aerodynamic shape and a trailing edge 324 which is formed with a corresponding aerodynamic shape and joined by side walls 326a, 326b of the seat tube 200 with the side walls 326 comprising an aerofoil shape. According to another aspect, the aerofoil cross-sectional shape 320 of the seat tube 200 may be truncated by the rear cutaway 207 as shown in FIG. 3. The aerofoil cross-sectional shape 320 may be truncated along the entire rear cutaway 207, or along a portion of the rear cutaway 207. For example, the top section 201 of the seat tube 200 is configured with the aerofoil cross-sectional shape 320 (i.e. the rear or trailing surface 206 in FIG. 2), and the aerofoil cross-sectional shape 320 is discontinued along the rear cutaway 207 and/or the bottom section 202 (FIG. 2) of the seat tube 200.

According to another embodiment, the seat post 130 is configured with a front edge 330 that is tangential to the curve of the seat tube 200, for example, as illustrated by line 332 in FIG. 3. According to another embodiment, the seat post 130 is configured with a front edge that while not aligned with the tangent of the curve of the seat tube 200 follows or continues the curve of the seat tube 200. This configuration allows for a more efficient transfer of forces between the seat post 130 and the seat tube 200 and the bicycle frame 110.

It will be appreciated that the seat tube according to the embodiments of the present invention as described above provides a number of features as follows: allows for a larger rear cutaway; allows for customization of bicycle frames from size to size with aesthetic visual aspects; and/or allows for tangential alignment of the seat post with the seat tube, and comprising various frame sizes.

In summary and according to an embodiment, there is provided a seat tube seat tube for use with a bicycle frame, the seat tube comprising: an upper section configured for attachment to a top tube in the bicycle frame; a lower section configured for attachment to a bottom bracket in the bicycle frame; and a curved section, the curved section spanning at least a portion between the upper section and the lower section.

In summary and according to another embodiment, there is provided a bicycle frame comprising: a bottom bracket; a top tube, a head tube, a down tube and a seat tube; one end of the top tube and one end of the down tube being affixed to the head tube, and another end of the top tube being affixed to one end of the seat tube; first and second seat stays, and first and second chain stays, and one end of each of the seat stays being affixed to the seat tube, and another end of each of the seat stays being affixed to respective ends of the chain stays; another end of the down tube and another end of the seat tube and another end of each of the chain stays forming a juncture for connecting or affixing the bottom bracket; the seat tube comprising, an upper section configured for attachment to the top tube in the bicycle frame; a lower section configured for attachment to the bottom bracket in the bicycle frame; and a curved section, the curved section spanning at least a portion between the upper section and the lower section.

The present invention may be embodied in other specific forms without departing from its spirit or essential characteristics. The embodiments described and disclosed are to be considered in all aspects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A seat tube for use with a bicycle frame, said seat tube comprising:
an upper section configured for attachment to a top tube in the bicycle frame;
a lower section configured for attachment to a bottom bracket in the bicycle frame; and
a curved section, said curved section spanning at least a portion between said upper section and said lower section.

2. The seat tube as claimed in claim 1, wherein said curved section comprises a continuous concave shaped curve.

3. The seat tube as claimed in claim 1, wherein said curved section comprises one or more discontinuous concave shaped sections.

4. The seat tube as claimed in claim 2, further comprising a front edge and a rear edge, and said front edge and said rear edge being joined by respective side walls, and wherein said curved section is formed in at least a portion of said curved section.

5. The seat tube as claimed in claim 4, wherein said rear edge comprises a rear cutaway extending from said bottom bracket substantially to said top section and comprising a radial shape configured for a rear wheel.

6. The seat tube as claimed in claim 4, wherein said front edge and said rear edge comprise an aerodynamic foil configured with said side walls.

7. The seat tube as claimed in claim 6, wherein said aerodynamic foil is truncated along at least a portion of said rear cutaway.

8. The seat tube as claimed in claim 2, wherein said upper section comprises a concave rear surface configured to accommodate a rear brake assembly.

9. A bicycle frame comprising:
a bottom bracket;
a top tube, a head tube, a down tube and a seat tube;
one end of the top tube and one end of the down tube being affixed to the head tube, and another end of the top tube being affixed to one end of the seat tube;
first and second seat stays, and first and second chain stays, and one end of each of the seat stays being affixed to the seat tube, and another end of each of the seat stays being affixed to respective ends of the chain stays;
another end of the down tube and another end of the seat tube and another end of each of the chain stays forming a juncture for connecting or affixing the bottom bracket;
said seat tube comprising, an upper section configured for attachment to the top tube in the bicycle frame,
a lower section configured for attachment to the bottom bracket in the bicycle frame; and
a curved section, the curved section spanning at least a portion between the upper section and the lower section.

10. The seat tube as claimed in claim 9, wherein said curved section comprises a continuous concave shaped curve.

11. The seat tube as claimed in claim 9, wherein said curved section comprises one or more discontinuous concave shaped sections.

12. The seat tube as claimed in claim 10, further comprising a front edge and a rear edge, and said front edge and said rear edge being joined by respective side walls, and wherein said curved section is formed in at least a portion of said curved section.

13. The seat tube as claimed in claim 12, wherein said rear edge comprises a rear cutaway extending from said bottom bracket substantially to said top section and comprising a radial shape configured for a rear wheel.

14. The seat tube as claimed in claim 12, wherein said front edge and said rear edge comprise an aerodynamic foil configured with said side walls.

15. The seat tube as claimed in claim 14, wherein said aerodynamic foil is truncated along at least a portion of said rear cutaway.

16. The seat tube as claimed in claim 10, wherein said upper section comprises a concave rear surface configured to accommodate a rear brake assembly.

17. The bicycle frame as claimed in claim 9, wherein said upper section comprises a concave rear surface configured to provide a transition between said seat stays and said seat tube.

18. The bicycle frame as claimed in claim 9, wherein said upper section is configured to receive a seat post, and said seat post having a front edge configured to form a tangential relationship with said curved section of said seat tube.

19. The bicycle frame as claimed in claim 18, wherein said upper section extends above said top tube.

20. The bicycle frame as claimed in claim 19, wherein said upper section comprises an aerodynamic foil extending from a leading edge to a trailing edge.
